(19) United States
(12) Patent Application Publication
(10) Pub. No.: US 2009/0099733 A1
(43) Pub. Date: Apr. 16, 2009

(54) Method and device for activating restraining means

(76) Inventor: Marc Theisen, Besigheim (DE)

Correspondence Address: KENYON & KENYON LLP, ONE BROADWAY, NEW YORK, NY, 10004, US

(21) Appl. No.: 10/582,409

(22) PCT Filed: Oct. 7, 2005
(86) PCT No.: PCT/EP2005/055086

§ 371 Date: Dec. 18, 2008

(30) Foreign Application Priority Data
Dec. 13, 2004 (DE) 10 2004 059 908.4

(51) Int. Cl. B60R 21/01

(52) U.S. Cl. 701/46; 701/45

(57) ABSTRACT

A method and a device for activating a restraining arrangement, in which the restraining arrangement is triggered as a function of the crash type and/or the crash severity. The crash type is derived from a signal characterizing the crash. The crash type is ascertained by analyzing signal and slope values of the signal characterizing the crash using threshold values. The crash severity is derived from the crash type and information about the velocity of vehicle.

### FIELD OF THE INVENTION

The exemplary embodiment and/or exemplary method of the present invention relates to a method and a device for activating a restraining arrangement, in particular for calculating the crash type based on a slope function as a function of relative velocity and for calculating the crash severity from velocity and crash type, triggering being able to be performed on the basis of both the crash type and the crash severity.

### BACKGROUND INFORMATION

The use of a slope function which calculates the area between a signal identifying a crash and a velocity-independent threshold in connection with triggering a restraining arrangement is discussed in German patent document no. 101 55 751 A1. The variable calculated therefrom is compared to a further threshold in order to ascertain a signal slope of the original signal.

GERMAN PATENT DOCUMENT NO. 101 41 886 A1 discusses a device and a method for activating a restraining arrangement, in which a velocity reduction of the vehicle and the slope in the curve of the velocity reduction are ascertained from acceleration signals. A crash type is then ascertained on the basis of these variables and further variables such as impact velocity and impact time. A precrash sensor system is used to ascertain impact time and impact velocity.

Algorithms which calculate the crash type and, on the basis of the ascertained crash type, the crash severity in order to find the triggering decision of a restraining arrangement are discussed in GERMAN PATENT DOCUMENT NO. 102 53 227 A1.

### SUMMARY OF THE INVENTION

By using the relative velocity information, the crash type may be ascertained reliably and precisely. In addition, the crash severity is precisely calculated from the relative velocity information and the crash type. It should be noted that the crash type is ascertained in one embodiment using the method described in the following, while the crash severity is calculated via another method. In another embodiment, the opposite is true, i.e., the crash type is established via another method and the crash severity is calculated via the method described in the following for calculating the crash severity. Of course, in another embodiment, both the crash type and the crash severity are calculated using the method described in the following.

The crash severity is understood here as the information which describes either the severity of the crash itself or the restraining arrangement to be triggered, i.e., whether the pyrotechnic belt tensioner or the airbag are to be triggered in the first or second stage, for example.

By ascertaining the crash type from a combined condition for signal value and slope, the crash type may be calculated reliably and precisely. Furthermore, this procedure requires little outlay in regard to computing time and memory space when it is executed on a control unit. Moreover, it ensures good generalization of the crash tests to crashes which occur in the field. The velocity-dependent establishment of the threshold for the signal value and the slope value also contributes to these advantages.

By ascertaining the crash severity from the crash type and the velocity information, it is possible to implement the requirements of the vehicle manufacturer in regard to the triggering times of the restraining arrangement very precisely in the control unit, since the vehicle manufacturer specifies the required restraining arrangement triggering times for crashes of a specific velocity and a specific crash type.

Further advantages result from the following description of the embodiments, as described herein.

### BRIEF DESCRIPTION OF THE DRAWINGS

FIG. 1 shows a device for controlling a restraining arrangement which is designed to perform the method described in the following.

FIG. 2 shows a time diagram(s), on the basis of which the procedure for crash type recognition is explained.

FIG. 3 shows another time diagram(s), on the basis of which the procedure for crash type recognition is explained.

FIG. 4 shows another time diagram(s), on the basis of which the procedure for crash type recognition is explained.

FIG. 5 shows another time diagram(s), on the basis of which the procedure for crash type recognition is explained.

FIG. 6 shows a table which is analyzed for the crash type recognition.

FIG. 7 shows a table, on the basis of which the procedure for ascertaining the crash severity is described.

### DETAILED DESCRIPTION

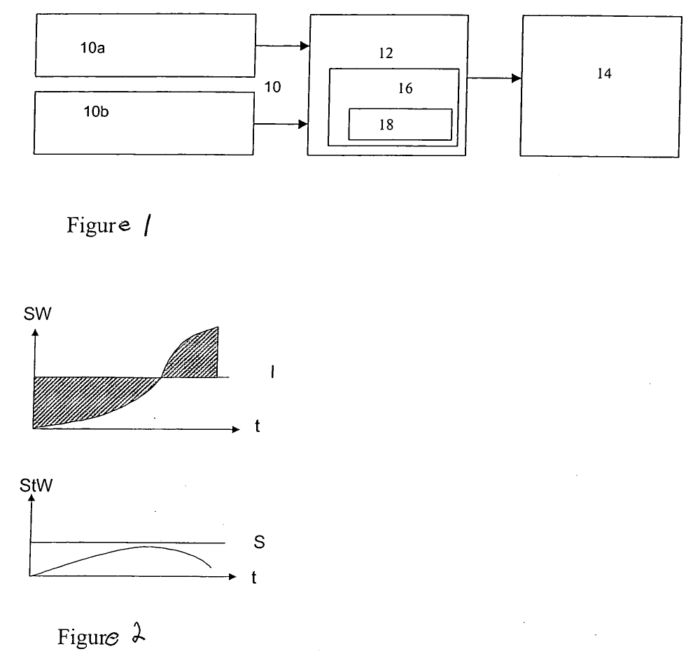

FIG. 1 shows a device for controlling a restraining arrangement which is designed to perform the method described in the following. It essentially includes three components: sensor system 10, control unit 12, and a restraining arrangement 14. Sensor system 10 includes at least one impact sensor 10a and one forward-looking sensor 10b. Impact sensor 10a may be implemented in the form of an acceleration sensor or a pressure sensor and forward-looking sensor 10b may be implemented in the form of an ultrasonic, radar, or video sensor. Control unit 12 inputs the sensor data and calculates the triggering decision of corresponding restraining arrangement 14 therefrom. Control unit 12 includes at least one processor 16, on which algorithm 18, explained in greater detail in the following, is executed. In one embodiment, this algorithm implements one or both of the methods described in the following. Restraining arrangement 14 is activated by the control unit may be air bags or pyrotechnic belt tensioners, for example.

In the framework of deriving a triggering variable for the restraining arrangement, a signal of the impact sensor, such as an acceleration signal, is analyzed to form a slope function (see FIG. 2). The area between the signal of the impact sensor (signal value SW) and a threshold (integration threshold I) is ascertained. The variables calculated therefrom, slope values (StW), are compared to a further threshold (slope threshold S), in order to judge or evaluate the signal slope of the original signal on the basis thereof (see FIG. 2).

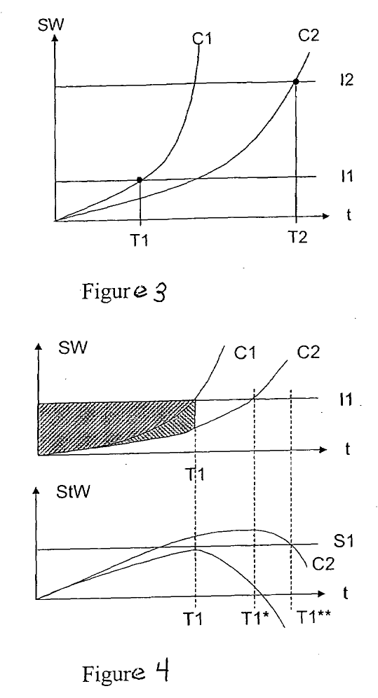

The goal of the method for crash type recognition is (see FIG. 3) to recognize a crash C1 at an instant T1 as hard and a crash C2 at an instant T2 as soft, crashes C1 and C2 belonging to the same velocity class, i.e., the vehicle colliding with an obstruction at a comparable velocity. In order to allow crash type recognition, a signal derived from the acceleration signal (e.g., a signal integrated from the acceleration signal such as the first or second windowed integral of the acceleration signal) or the acceleration signal itself, i.e., a signal which characterizes a crash, is analyzed. This signal is identified in FIG. 3 by signal value SW. An integration threshold I1 is established in such a way that the signal value curve intersects threshold I1 during crash C1 at required instant T1 (see FIG. 3). Similarly, an integration threshold I2 is established in such a way that the signal value curve intersects threshold I2 during crash C2 at required instant T2. Integration thresholds I1 and I2 and times T1 and T2 are established on the basis of signals from simulation experiments or crash tests.

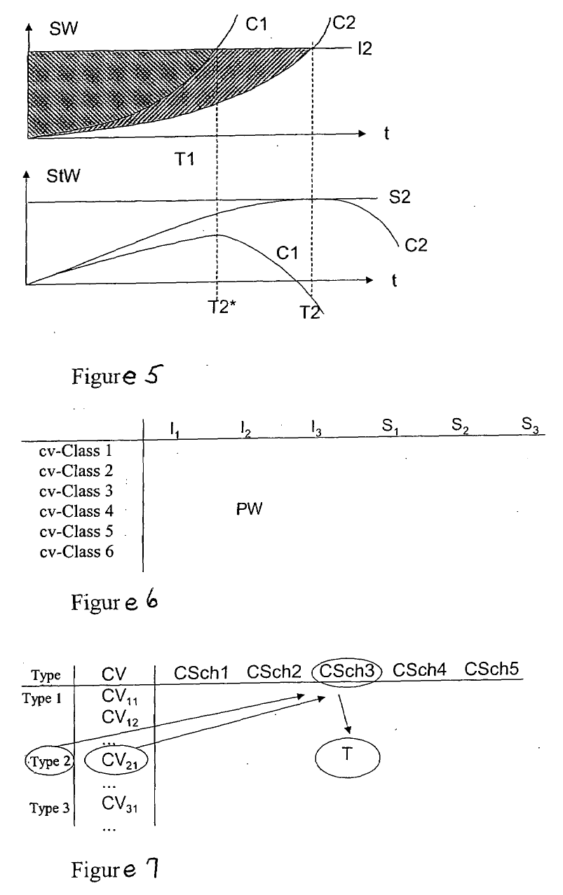

FIGS. 4 and 5 show the corresponding established values for the slope signal, which were obtained from the signal illustrated in FIG. 3. The diagrams shown at the top of FIGS. 4 and 5 correspond to the diagram of FIG. 3. Thresholds S1 and S2 for the slope signal are defined in such a way that S1 is greater than the slope value of the signal during a crash C1 at least at instant T1, and if possible over the entire signal curve (see FIG. 4). Analogously, slope threshold S2 is established in such a way that it is greater at instant T2 than the slope value of the signal during a crash C2 (see FIG. 5).

Using these 4 thresholds (I1, I2, S1, S2) the crashes may be classified in accordance with their hardness. Crash C1 is recognized as hard when the signal value exceeds I1 and the slope value is less than threshold S1. In accordance with the definition of I1 and S1, this is fulfilled at instant T1 (see FIG. 4). Accordingly, C2 is recognized as a soft crash when the signal value of C2 exceeds threshold I2 and when the slope value is less than threshold S2. This is given at instant T2 (see FIG. 5). Thresholds S1 and S2 are also established on the basis of signals from crash tests and/or simulations.

For crash type recognition and possibly for triggering the restraining arrangement, the signal characterizing the crash (SW) is subjected to integrations in relation to thresholds I1 and I2 and the slope values derived therefrom are compared to thresholds S1 and S2. Furthermore, the signal is compared to thresholds I1 and I2. If the signal exceeds threshold I1 and/or I2 and if corresponding threshold S1 and/or S2 is/are exceeded, the crash type corresponding to the exceeded threshold (I1/S1 hard crash or I2/S2 soft crash) is recognized and the restraining arrangement are triggered, if necessary.

As shown in FIG. 5, crash C1 is also recognized as a soft crash at instant T2*, but it has already been recognized as a hard crash at T1. Since T1 is chronologically before T2*, this is not a problem. For example, by producing a maximum in regard to the hardness of the crash type, the soft crash type may be suppressed, so that only the hard crash type is recognized.

However, soft crash C2 must be prevented from being recognized as the hard crash type at instant T1* (see FIG. 4). At this instant, the first part of the condition, that the signal value of C2 is greater than I1, is fulfilled. Therefore, S1 must be defined in such a way that it is also lower at instant T1* than the slope value of C2 at instant T1* (see FIG. 4). The second part of the condition for recognizing the hard crash type is thus not fulfilled. However, it is possible that there is an instant T1**, at which the signal value of C2 is greater than I1 and the slope value of C2 falls below threshold S1 (see FIG. 4). At this instant, the condition would then be fulfilled, so that soft crash C2 would be recognized as hard. This must be suppressed by a further auxiliary condition. For example, it may be checked that no excess or shortfall occurs precisely at this instant or that the slope value has not previously exceeded the corresponding threshold. Not exceeding this threshold may relate either to the complete period of time since the start of the triggering algorithm or to a shorter period of time to be defined. A further possibility is that the maximum value of the slope function is retained, so that in the event of falling slope values, the maximum value is always provided. At instant T1**, the slope value is then greater than S1, the second part of the condition is not fulfilled, and soft crash C2 will not be recognized as hard. Further possibilities for suppression so that the soft crash is not recognized as a hard crash type are also conceivable.

By incorporating further integration threshold values I3, I4, etc., and further slope threshold values S3, S4 etc., the method may be expanded to recognize more than two crash types.

By defining a continuous transition between the integration threshold values and the slope threshold values (for example, through interpolation between the values), it is also possible to determine a continuously defined crash type.

Up to this point, it has been assumed that all observed crashes belong to the same relative velocity class. Therefore, the described method may be used when all crashes are assigned to the same velocity class. In order to allow a velocity-dependent recognition of the crash type, the crashes are divided into more than one velocity class. The velocity classes are identified in the following by cv-class1, cv-class2, etc. It is then possible to define different parameter values PW for integration thresholds I1, I2 etc., and for slope threshold S1, S2 etc., for each velocity class. This may be performed in a table as shown in FIG. 6, for example. The parameter values are established as noted above on the basis of experiments and/or simulations. Defining a continuous transition between the discrete velocities through interpolation, for example, is also conceivable here.

The relative velocity is ascertained using a precrash sensor system, for example. Ascertaining the relative velocity using another method or estimating it via the intrinsic velocity, for example, is also conceivable. A velocity class is selected as a function of the measured relative velocity and the corresponding parameter values for thresholds I and S are read out. The signal characterizing the crash is then analyzed as explained above to ascertain the crash type and/or to trigger the restraining arrangement using the parameter values read out.

For calculating the crash severity, which may be performed alone or as a supplement to the crash type recognition, it is assumed that the crash type has been previously ascertained. This may be performed via the method described above. However, other methods are also conceivable. Thus, for example, it is possible to recognize the crash type via a precrash sensor system. Furthermore, it is assumed that there is a value for the relative velocity.

This velocity may be measured by a precrash sensor system, for example, or calculated or estimated via other methods. One variation of the estimation is to approximate it using the intrinsic velocity.

Crash type (type) and velocity (CV) are the two inputs required for the method in order to ascertain the crash severity (CSch) therefrom via a table, for example (see FIG. 7). The harder the crash type and the higher the velocity, the higher the crash severity in general. In the table, a specific crash severity value (Csch1-Csch5) is assigned to a specific combination of crash type (type) and relative velocity (CV). In the example, a crash severity Csch3 results from crash type type2 and relative velocity CV21.

Since the procedure for ascertaining the crash type ensures that the crash type is calculated at the required instant (e.g., T1 or T2), the crash severity is also first ascertained at the required instant when this procedure is used. The time control is thus performed by the crash type recognition. Alternatively, the time control is performed by a third independent method.

It is also possible to define a continuous transition between the crash severities in the calculation of the crash severity. This may be performed, for example, by defining a continuous transition between the velocities or between the crash types or between the crash types and the velocities. This may be performed, for example, by replacing the implementation of the table with multiple velocity-dependent characteristic curves, which may be different for the individual crash types, or by replacing the table with characteristic curves dependent on the crash type, which may be different for the individual velocities. Furthermore, it is also possible to replace the table with a continuous characteristic map which is a function of both the crash type and the velocity.

The restraining arrangement are then triggered at the suitable instant on the basis of the ascertained crash type and/or crash severity variable(s).

1-14. (canceled)

15. A method for activating a restraining arrangement in a vehicle, the method comprising:
determining a crash type from a signal characterizing the crash;
considering the crash type during a triggering of the restraining arrangement;
wherein the crash type is determined by analyzing signal values and slope values of the signal characterizing the crash using threshold values.

16. A method for activating a restraining arrangement in a vehicle, the method comprising:
determining a crash severity from a crash type and from information about a velocity of the vehicle; and
activating the restraining arrangement as a function of the crash severity

17. The method of claim 16, wherein the crash type is determined by analyzing signal values and slope values of a signal characterizing the crash using threshold values.

18. The method of claim 15, wherein the threshold values are predefined as a function of a velocity.

19. The method of claim 18, wherein the velocity is a relative velocity of the vehicle in relation to an obstruction before an impact.

20. The method of claim 15, wherein the threshold values are established so that for a specific crash type, the threshold values are intersected at an instant predefined for the specific crash type.

21. The method of claim 18, wherein the threshold values are determined one of discretely and continuously as a function of at least one the velocity and the crash type.

22. The method of claim 15, wherein if it is determined that there are at least two crash types, a hardest one of the at least two crash types is used as the crash type.

23. The method of claim 17, wherein a maximum slope value is retained.

24. The method of claim 17, wherein the threshold value for a slope value is defined so that at an instant at which a signal value exceeds its threshold value for a soft crash, it is less than a slope value for the soft crash.

25. The method of claim 17, wherein a threshold value for a slope value is defined so that one of exceeding and falling below occurs when a signal value exceeds its threshold value.

26. A device for activating a restraining arrangement, comprising:
a control unit which considers a crash type, the crash type being determined from a signal characterizing the crash, to activate the restraining arrangement;
wherein the control unit determines the crash type by analyzing the signal and slope values of the signal characterizing the crash using threshold values.

27. A device for activating a restraining arrangement in a vehicle, comprising:
a control unit to activate the restraining arrangement as a function of a crash severity, wherein the control unit determines the crash severity from a crash type and from information about a velocity of the vehicle.

28. The device of claim 27, wherein the crash type is determined one of discretely, continuously, and a combination of discretely and continuously.
